(19) United States
(12) Patent Application Publication
(10) Pub. No.: US 2025/0330228 A1
(43) Pub. Date: Oct. 23, 2025

(54) METHOD AND APPARATUS OF RADIO RESOURCE DETERMINATION

(71) Applicant: LENOVO (BEIJING) LIMITED, Beijing (CN)

(72) Inventors: Hongmei Liu, Beijing (CN); Yuantao Zhang, Beijing (CN); Zhi Yan, Beijing (CN); Ruixiang Ma, Beijing (CN); Haiming Wang, Beijing (CN)

(21) Appl. No.: 19/112,492

(22) PCT Filed: Sep. 27, 2022
(86) PCT No.: PCT/CN2022/121691

§ 371 Date: Mar. 17, 2025

(51) Int. Cl. H04B 7/06; H04L 5/00; H04W 72/0446

(52) U.S. Cl. CPC H04B 7/06952; H04L 5/0098; H04W 72/0446

(57) ABSTRACT

Embodiments of the present application are related to a method and apparatus of radio resource determination. According an embodiment of the present application, an exemplary method includes: receiving, by a network node from another network node, first information indicating at least one first set of beams for a link between the network node and a remote apparatus; and determining an association between beams and time domain resources for the link between the network node and the remote apparatus.

### TECHNICAL FIELD

Embodiments of the present application generally relate to wireless communication technologies, especially to a method and apparatus of radio resource determination, e.g., time domain resource determination for beam(s) between a repeater and a remote apparatus.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

According to RP-213592, smart repeaters (also referred to “network controller repeater”) will be studied and identified. In addition, according to RAN1 #110 agreement, time domain resources corresponding to an access link beam can be determined per beam indication. Since there are communications of various channels/reference signals (RSs) between the network side and remote side, time domain resources associated with all these channels/RSs should be accommodated by time domain resources configured or predefined for one or more beams. These channels/RSs include but not limited to: synchronization signal (SS)/physical broadcast channel (PBCH) block (SSB), paging, resource occasion (RO), periodic channel state information-reference signal (CSI-RS), sounding reference signal (SRS), configured grant physical uplink shared channel (PUSCH), PUSCH repetition, semi-persistent scheduling (SPS) physical downlink shared channel (PDSCH) etc.

Accordingly, the industry needs to solve the technical problem on how to determine radio resource(s) for beam(s) for a link between a repeater and a remote apparatus to accommodate various channels/RSs.

### SUMMARY OF THE DISCLOSURE

One objective of the present application is to provide a technical solution of radio resource determination, especially a method and apparatus of determining radio resources, e.g., time domain resource(s) for beams for a link between a repeater and a remote apparatus.

Some embodiments of the present application provide a network node, e.g., a repeater, which includes: a transceiver; and a processor coupled to the transceiver, wherein the processor is configured to: receive, from another network node via the transceiver, first information indicating at least one first set of beams for a link between the network node and a remote apparatus; and determine an association between beams and time domain resources for the link between the network node and the remote apparatus.

In some embodiments of the present application, at least one time domain resource for the association is indicated by second information from the other network node indicating at least one of: a periodicity in time domain, an offset in time domain, a duration in time domain, a subcarrier spacing (SCS), a set of starting symbols within the duration, or a length of a time domain resource.

According to some embodiments of the present application, a length of a single symbol is determined by the SCS.

According to some embodiments of the present application, symbols are divided into symbol sets based on starting symbols and the length of a time domain resource, and each symbol set is associated with at least one beam of a corresponding set of the at least one first set of beams.

In some scenarios, a number of beams associated with each symbol set is configured by the other network node.

In some scenarios, determining an association between beams and time domain resources includes: mapping beams to symbol sets in a sequential manner or a cyclic manner. For example, in the case that a number of beams in the corresponding set of the at least one first set of beams is less than a number of the symbol sets, the beams in the corresponding set will be mapped to the symbol sets with repetitions in sequence, wherein in each repetition, the beams will be mapped in the sequential manner or the cyclic manner to a corresponding subset of the symbol sets.

In some scenarios, in the case that there is only one beam in the corresponding set of the at least one first set of beams, all the symbol sets will be associated with the only one beam.

In some scenarios, in the case that a number of beams in the corresponding set of the at least one first set of beams is same as a number of the symbol sets, the beams in the corresponding set and the symbol sets are one to one associated.

In some embodiments of the present application, at least one time domain resource for the association is indicated by second information from the other network node indicating a set of time domain patterns, each time domain pattern is associated with an index.

According to some embodiments of the present application, each time domain pattern is associated with at least one of the following: a frame level periodicity, an offset in time domain, at least one of a set of subframe or a set of first slot, a number of second slots, at least one starting symbol within the second slots, a number of occasions within the second slots, or a duration of an occasion. In some scenarios, a set of time domain occasions is determined based on each time domain pattern. Determining an association between beams and time domain resources includes: starting or restarting mapping between beams in a corresponding set of the at least one first set of beams and the set of time domain occasions based on a set of starting time domain positions configured by the other network node.

In some embodiments of the present application, at least one time domain resource for the association is determined by a set of predefined time domain patterns, and each predefined time domain pattern is associated with an SCS or a band index.

According to some embodiments of the present application, each predefined time domain pattern indicates at least one of: a periodicity, an offset in time domain, a predefined duration in time domain, a set of slots and a set of starting symbols within each of the set of slots, or a predefined length of a time domain resource.

According to some embodiments of the present application, at least one symbol set will be determined based on each predefined time domain pattern. In some scenarios, determining an association between beams and time domain resources includes: starting or restarting mapping beams in a corresponding set of the at least one first set of beams to each of the at least one symbol set based on the offset.

According to some embodiments of the present application, a second set of beams of a subset of a set of the at least one first set of beams is indicated; and in the case that a beam in the set of the at least one first set beams is also in the second set, the network node will be on for a symbol set corresponding to the beam, otherwise, the network node will be off for a symbol set corresponding to the beam.

In some embodiments of the present application, at least one time domain resource for the association is indicated by second information indicating at least one of: a slot level offset with respect to a signaling carrying the first information or a signaling carrying the second information, a start and length indicator value (SLIV) to indicate a starting symbol and length of symbols within a slot, a number of symbols, a repetition number, and a direction indicator indicating whether a time domain resource is for downlink or uplink.

According to some embodiments of the present application, in the case that a direction of a time domain resource is same as that determined based on time division duplex (TDD) configuration, the time domain resource will be associated with a corresponding beam. In some scenarios, the TDD configuration is determined based on at least one of: TDD configuration common, TDD configuration dedicated, group common downlink control information (DCI) or dynamic side control information.

In some embodiments of the present application, in the case that there is more than one association between beams and time domain resources, each association will be associated with a priority, and an association with a highest priority of the more than one association will be determined for a time domain resource for the link between the network node and the remote apparatus.

According to some embodiments of the present application, the priority for each association is configured or is determined based on a corresponding time domain pattern.

In some embodiments of the present application, each of the at least one first set of beams is associated with a beam set index.

In some embodiments of the present application, a default beam will be determined for a time domain resource without configured beam, and the default beam is configured, or is determined based on a latest beam, or is determined based on a beam with a lowest index.

In some embodiments of the present application, there are multiple beams associated with a time domain resource, and each beam is for a frequency domain resource

According to some embodiments of the present application, the frequency domain resource is a band, a carrier, a bandwidth part (BWP), a set of resource blocks (RBs) or a set of resource block groups (RBGs).

According to some embodiments of the present application, the frequency domain resource is based on a starting position and a number of RBs.

Some other embodiments of the present application also provide a network node, e.g., a gNB, which includes: a transceiver; and a processor coupled to the transceiver, wherein the processor is configured to: transmit, to another network node via the transceiver, first information indicating at least one first set of beams for a link between the other network node and a remote apparatus; and determine an association between beams and time domain resources for the link between the other network node and the remote apparatus.

Some yet other embodiments of the present application provide a method, e.g., performed by a repeater, which includes: receiving, by a network node from another network node, first information indicating at least one first set of beams for a link between the network node and a remote apparatus; and determining an association between beams and time domain resources for the link between the network node and the remote apparatus.

Some yet other embodiments of the present application also provide a method, e.g., performed by a gNB node, which includes: transmitting, to a network node, first information indicating at least one first set of beams for a link between the network node and a remote apparatus; and determining an association between beams and time domain resources for the link between the network node and the remote apparatus.

Given the above, embodiments of the present application provide a technical solution of radio resource determination, e.g., determining time domain resource(s) for beam(s) between a repeater and a UE, which can accommodate various channels/RSs and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates a schematic diagram of an exemplary wireless communication system in a non-multi-TRP scenario according to some embodiments of the present application.

FIG. 3 illustrates a schematic diagram of an exemplary wireless communication system in a multi-TRP scenario according to some other embodiments of the present application.

FIG. 4 is a flow chart illustrating an exemplary procedure of a method of radio resource determination according to some embodiments of the present application.

FIG. 5 is a schematic diagram illustrating an exemplary time domain resource and beam association according to some embodiments of the present application.

FIG. 6 is a schematic diagram illustrating an exemplary time domain resource and beam association according to some other embodiments of the present application.

FIG. 7 illustrates a block diagram of an exemplary apparatus of radio resource determination according to some embodiments of the present application.

FIG. 8 illustrates a block diagram of an exemplary apparatus of radio resource determination according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

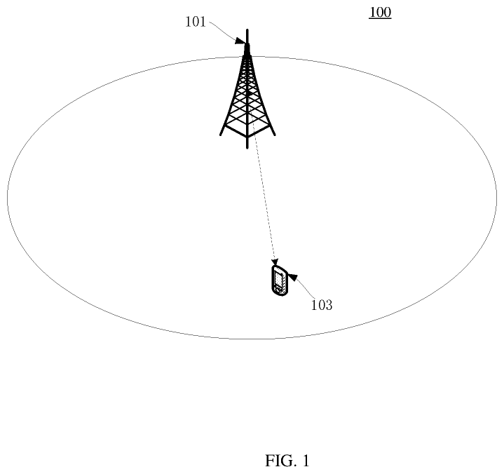

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one TRP (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPool Index value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

To enhance the coverage area of a BS, relay nodes, such as repeaters may be deployed in a wireless communication system, which can improve the throughput of a mobile device in low signal quality, e.g., a UE that locates in a coverage hole or far from the BS.

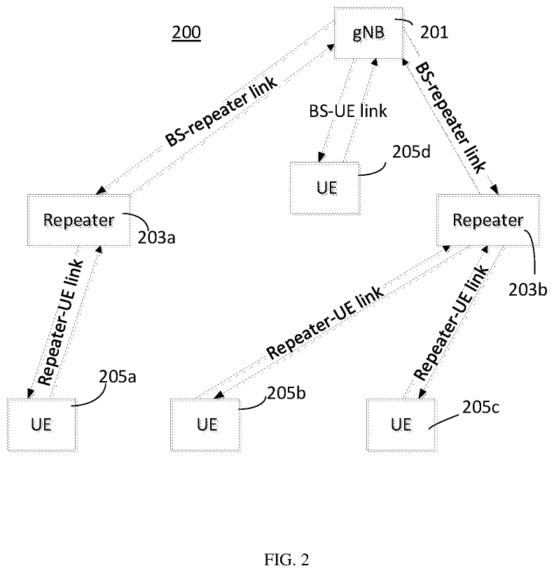

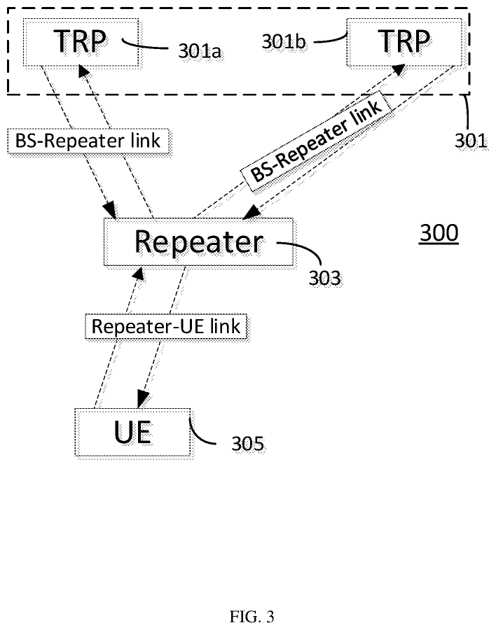

FIG. 2 and FIG. 3 respectively illustrate an exemplary scenario of a wireless communication system with repeaters, wherein FIG. 2 illustrates a schematic diagram of an exemplary wireless communication system 200 in a non-multi-TRP scenario according to some embodiments of the present application, and FIG. 3 illustrates a schematic diagram of an exemplary wireless communication system 300 in a multi-TRP scenario according to some other embodiments of the present application.

Referring to FIG. 2, in the exemplary wireless communication system 200, there are multiple nodes, e.g., a gNB 201, a first repeater 203a, a second repeater 203b, a first UE 205a, a second UE 205b, a third UE 205c and a fourth UE 205d. The gNB 201 may be configured with a single TRP or not. The first repeater 203a is connected with the gNB 201 and the first UE 205a, the second repeater 203b is connected with the gNB 201 and the second UE 205b and the third UE 205c. A link between a BS, e.g., the gNB 201 and a repeater, e.g., the first repeater 203a or the second repeater 203b can be referred to a BS-repeater link (or gNB-repeater link, backhaul link), a link between a repeater, e.g., the first repeater 203a and a UE, e.g., the first UE 205a can be referred to a repeater-UE link or access link; and a link between a BS, e.g., the gNB 201 and a UE, e.g., the fourth UE 205d can be referred to as a BS-UE link (or gNB-UE link).

Persons skilled in the art should well know that each BS, e.g., the gNB 201 can connect with one or more repeaters, e.g., the first repeater 203a and second repeater 203b, and one or more UEs, e.g., the first UE 205a, the second UE 205b, the third UE 205c and the fourth UE 205d; and each repeater, e.g., the first repeater 203a and the second repeater 203b can connect with one or more BSs and one or more UEs. Thus, the exemplary nodes in the wireless communication system 200 with a limited number should not be deemed as the limitation to the present application.

Referring to FIG. 3, in the exemplary wireless communication system 300, there are multiple nodes, e.g., a gNB 301, a repeater 303 and a UE 305, wherein the gNB 301 is configured with (or associated with) two TRPs, e.g., a first TRP 301a and a second TRP 301b. The repeater 303 is connected with each of the first TRP 301a and the second TRP 301b. Thus, there two links between the gNB 301 and the repeater 303, one is a BS-repeater link (or gNB-repeater link, or TRP-repeater link) between the first TRP 301a and the repeater 303 and the other is a BS-repeater link (or gNB-repeater link, or TRP-repeater link) between the second TRP 301b and the repeater 303.

Different from legacy repeater, network controllable repeaters (or smarter repeaters) are transparent to UEs and can maintain the BS-repeater link and repeater-UE link simultaneously. Although some issues concerning network controllable repeaters have been discussed and solved, there are still multiple technical problems needed to be solved in some scenarios. For example, in a scenario of various channel and/or RS communications on the repeater-UE link, time domain resources associated with all the channels and/or RSs should be accommodated by the time domain resource configuration for beams for the repeater-UE link.

At least to solve the above technical problem, embodiments of the present application propose a technical solution of radio resource determination, e.g., a method and apparatus of determining time domain resources for beams for a link, e.g., an access link between a repeater and a UE.

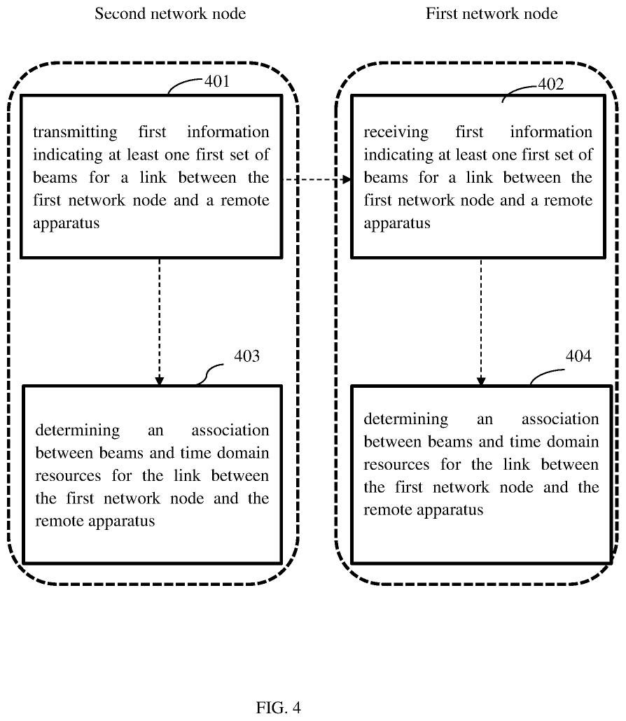

FIG. 4 is a flow chart illustrating an exemplary procedure of a method of radio resource determination according to some embodiments of the present application. Although the method is illustrated in a system level by a first network node, e.g., a repeater (e.g., a network controllable repeater) and a second network node, e.g., a BS (e.g., a gNB), persons skilled in the art should understand that the method implemented in the two network nodes can be separately implemented and/or incorporated by other apparatus with the like functions.

Referring to FIG. 4, the first network node, e.g., a repeater is deployed between the second network node, e.g., a gNB and a remote apparatus (third node), e.g., a UE, and may maintain at least one first link between the first network node and the second network node, e.g., at least one BS-repeater link and at least one second link between the first network node and the third node, e.g., at least one repeater-UE link simultaneously.

Persons skilled in the art should well know that herein (throughout the specification), wordings, such as “the first” and “the second” etc., are only used to distinguish similar features or elements etc., for clearness, and should not be deemed as limitation to the scope of the technical solutions.

The second network node, e.g., a gNB may configure at least one first set of beams for a link between the first network node, e.g., a repeater and UE. Each first set of beams include one or more beams, which may be transmission beam(s) or reception beam(s) or both of them. In addition, different first set of beams may be associated with different time domain and/frequency domain resource configurations.

Regarding the terminology “beam,” it has been well known by persons skilled in the art. However, it has not been defined in 3GPP specification, and thus may evolve into other terms. Each beam is associated with a spatial domain filter for transmission or reception (i.e., a spatial domain transmission or reception filter). Each beam can also be associated with at least one RS. For example, each beam or spatial domain filter is associated with at least one of: CSI-RS (or CSI-RS resource), or SSB, or SRS (or SRS resource), or transmission configuration indication (TCI) state, or joint TCI state, or spatial relation information etc. Each TCI state, or spatial relation information, or joint TCI state for at least one of downlink and uplink may be associated with one or two quasi co-located (QCL)-typeD RSs.

In step 401, the second network node will indicate the at least one first set of beams to the remote apparatus via first information, e.g., beam indication in various manners. For example, the first information may be transmitted or configured via system information block 1 (SIB1), RRC, media access control (MAC) control element (CE) or DCI (e.g., group common DCI) etc. The at least one first set of beams can be directly indicated in the first information, e.g., each beam is associated with a beam index, that is, each first set of beams is indicated as a first set of beam indexes. In some other embodiments, the at least one first set of beams can be indirectly determined from the first information, e.g., based on associated RSs, or associated time-frequency resources etc. indicated in the first information. In some yet other embodiments of the present application, each first set of beams may be associated with a beam set index. In some yet other embodiments of the present application, a default beam will be determined for a time domain resource without configured beam, which may be different or identical for uplink and downlink. The default beam is configured, or is determined based on a latest beam (or previous beam), or is determined based on a beam with a lowest index or is determined based on other manners. In such cases, the first information refers to the information for determining the default beam.

Accordingly, in step 402, the first network node will receive the first information. Based on the at least one first set of beams, the second network node, e.g., the gNB will determine an association between beams and time domain resources for the link between the first network node and the remote apparatus in step 403 (which may be performed before or after the step 401). Similarly, the first network node, e.g., the repeater will determine an association between beams and time domain resources for the link between the first network node and the remote apparatus in step 404. The determined association between beams and time domain resources will at least ensure that time domain resource(s) associated with all related channel(s) and/or RS(s) are accommodated by time domain resource configuration for beams for the link between the first network node and the remote apparatus. Regarding the time domain resources to be associated with the beams, they can be predefined or configured to the first network node in different scenarios. In some scenarios, beams associated with frequency domain resources and/or panels will also be determined.

A single or multiple association (or mapping) solutions can be used according to some embodiments of the present application, and a single association between beams and time domain resources or multiple associations between beams and time domain resources can be determined. In the case that there are multiple associations being determined, one association will be further determined and the corresponding time domain resources will be determined for the link between the first network node and the remote apparatus.

Hereafter, taking a repeater as an example of the first RAN node, taking a gNB as an example of the second RAN node, and taking a UE as an example of the remote apparatus, more details on how to determine radio resources (e.g., time domain resources and/or frequency domain resources etc.) will be illustrated below in view of various exemplary embodiments (or schemes) of the present application. Persons skilled in the art should well know that the illustrated solutions can also be applied to other nodes with the like functions in a wireless communication system. In addition, although different exemplary embodiments are illustrated focusing on different technical measures for clearness, they can be combined in various manners by persons skilled in the art under the disclosure and teaching of the present application while not specifically illustrated. Moreover, the determined association in the first network node (repeater side) and the second network node (gNB side) are consistent, and thus although some embodiments are illustrated only on the repeater side, persons skilled in the art should well know the operations in the gNB side.

### Scheme 1

In some embodiments of the present application, at least one time domain resource (e.g., symbols or symbol sets) for association is indicated to the first network node, e.g., a repeater by the second network node, e.g., a gNB. The symbols or symbol sets can be corresponding to at least one of CSI-RS, SRS or PDCCH, etc. Exemplary second information from the gNB to the repeater may indicate at least one of: a periodicity in time domain, an offset in time domain, a duration in time domain, an SCS, a set of starting symbols within the duration, or a length of a time domain resource. A length of a single symbol can be determined by the SCS in some embodiments of the present application.

For example, the second information may indicate a periodicity in time domain, an offset in time domain, a duration in time domain, an SCS, a set of starting symbols within the duration, and a length of a time domain resource; and the time domain resources can be determined based on the second information. In another example, the second information may only indicate a periodicity in time domain, an offset in time domain, and a duration in time domain configured with respect to a SCS; and the time domain resources will be determined based on the second information in combination with other related information e.g., SCS etc. predefined (or preconfigured) to the repeater. In yet another example, the second information is or includes a bitmap to indicate a set of starting symbol index within a duration or within each slot of the duration.

Regarding the length of a time domain resource, it can also be referred to “symbol length” or “symbol number” etc., which indicates how many symbols are associated with the starting symbol index, i.e., the number of symbols associated with the starting symbol index. According to some embodiments of the present application, symbols may be divided into symbol sets based on the starting symbols and the length of a time domain resource, and each symbol set is associated with at least one beam of a corresponding beam set indicated by the gNB. How many beams are associated with each symbol set, i.e., the number of beams associated with each symbol set is configured or predefined by the gNB in some scenarios.

One or more configured beams (which may be indicated in a beam set or in a beam pattern) will be associated with (or mapped with) the at least one time domain resource, e.g., in a sequential manner or a cyclic manner or other manners. In the case that the symbols are divided into symbol sets, the one or more beams will be mapped to (or associated with) symbol sets in a sequential manner or a cyclic manner or other manners. The number of the one or more beams, e.g., indicated by beam indexes may be as the same as that of the symbol sets or smaller than that of the symbol sets. For example, in the case that the number of the one or more beams is less than the number of the symbol sets, the one or more beams will be mapped to the symbol sets with repetitions in sequence, wherein in each repetition, the beams will be mapped in the sequential manner or the cyclic manner to a corresponding subset of the symbol sets.

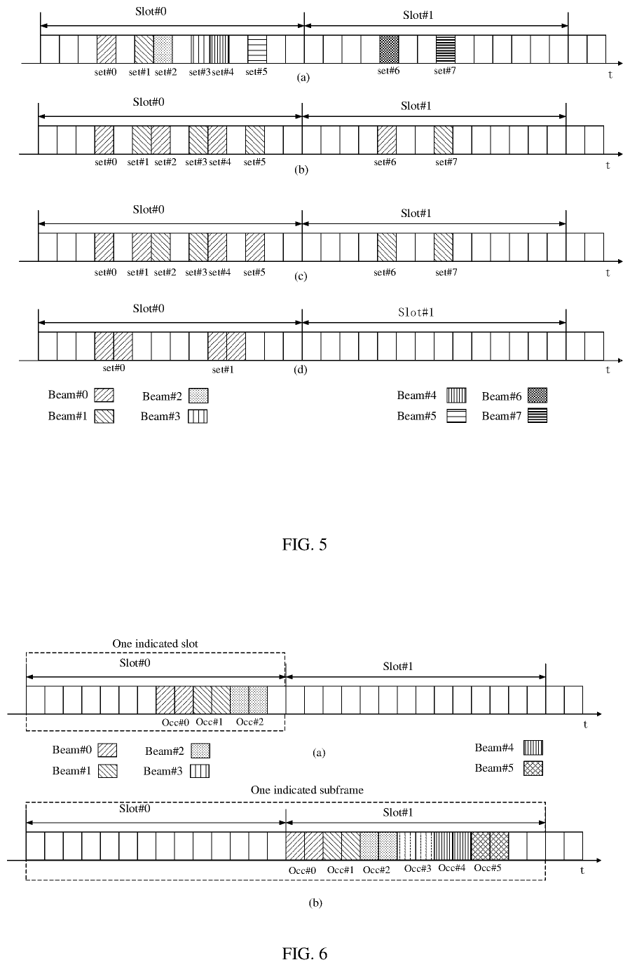

FIG. 5 is a schematic diagram illustrating an exemplary time domain resource and beam association according to some embodiments of the present application.

Referring to FIG. 5, in some scenarios (a), the illustrated duration is two slots, e.g., slot #0 and slot #1, each slot including 14 symbols. It is assumed that each symbol set associated with a starting symbol includes only one symbol, and the number of beams is as the same as or different from that of the symbol sets. The beams and the symbol sets can be one to one associated, e.g., each beam index is associated with a symbol set in sequence. Specifically, there are 8 symbol sets and 8 beams in the shown duration, wherein, there are 6 symbol sets (e.g., set #0 to set #5) and 6 beams (e.g., beam #0 to beam #5) in slot #0 and 2 symbol sets (e.g., set #6 and set #7) and 2 beams (e.g., beam #6 and beam #7) in slot #1, and each beam (or beam index) is associated with a symbol set. The illustrated mapping in the duration can be repeated in the time domain according to the periodicity or symbol sets.

In some scenarios (b) and (c), the duration is also two slots, e.g., slot #0 and slot #1, each slot including 14 symbols. It is assumed that each symbol set associated with a starting symbol includes only one symbol, and the number of beams, e.g., 2 is smaller than that of the symbol sets, e.g., 8. Then, the beams will be mapped to the symbol sets with repetition in sequence, wherein, in each repetition, the beams will be mapped to partial symbol sets (a subset of the symbol set, which may be divided with a number determined based on the number of the beams in sequence) of the whole symbol sets in a sequential manner (as illustrated in scenarios (b)) or the cyclic manner (as illustrated in scenarios (c)) until all the symbol sets are mapped. Specifically, there are 8 symbol sets in the shown duration, wherein, 6 symbol sets (e.g., set #0 to set #5) are in slot #0 and 2 symbol sets (e.g., set #6 and set #7) are in slot #1. 2 beams, e.g., beam #0 and beam #1 are mapped to the 8 symbol sets with repetitions, and each beam is associated with 4 symbol sets. In scenarios (b), there are two repetitions, wherein in the first repetition, the two beams are mapped to the first four symbol sets in a sequential manner; and in the second repetition, the two beams are mapped to the second four symbol sets in a sequential manner. In scenarios (c), there are also two repetitions, wherein in the first repetition, the two beams are mapped to the first four symbol sets in a cyclic manner; and in the second repetition, the two beams are mapped to the second four symbol sets in a cyclic manner. Similarly, the illustrated mapping in the duration can be repeated in the time domain according to the periodicity or symbol sets.

In some scenarios (d), the illustrated duration is one slot, e.g., slot #0, which includes 14 symbols. It is assumed that each symbol set associated with a starting symbol includes two symbols, and the number of beams is one. All the symbol sets will be associated with the only one beam. Specifically, there are 2 symbol sets, e.g., set #0 and set #1, each symbol set including 2 symbols. There is only one beam, e.g., beam #1 in the shown duration, e.g., slot #0, and the only one beam is associated with both of the two symbol sets. Similarly, the illustrated mapping in the duration can be repeated in the time domain according to the periodicity or symbol sets.

### Scheme 2

In some embodiments of the present application, at least one time domain resource for the association is indicated by second information from the gNB indicating a set of time domain patterns, wherein each time domain pattern is associated with an index (e.g., pattern index). This may be corresponding to RACH occasions. For example, one or more time domain patterns can be configured to the repeater by higher layer signaling indicating one or more pattern indexes, e.g., by SIB, RRC or MAC CE etc.

An exemplary time domain pattern is associated with at least one of the following: a frame level periodicity, an offset in time domain, at least one of a set of subframe or a set of first slots (e.g., a set of first slot indexes), the number of second slots (e.g., one or two), at least one starting symbol within the second slots, a number of occasions within the second slots, or a duration of an occasion. The second slots are partial or all of the first slots. In the case that the number of second slots is 1, the only one slot will be selected as the second slot. In the case that the number of second slots is 2, the second one of two first slots will be selected as the second slot. In some scenarios, a set of time domain occasions, e.g., a set of RACH occasions will be determined based on each time domain pattern alone (e.g., the time domain pattern indicates all required information) or in combination with other related information (e.g., the time domain pattern only indicates partial required information).

One or more configured beams (which may be indicated in a beam set or in a beam pattern) will be associated with (or mapped with) the at least one time domain resource. The mapping between beam and time domain resource will start or restart based on configured or predefined starting time domain positions. For example, in the case that a set of time domain occasions are determined, one to one mapping between beams and the set of time domain occasions will be started or restarted based on the set of starting time domain positions configured by the gNB in sequence.

FIG. 6 is a schematic diagram illustrating an exemplary time domain resource and beam association according to some other embodiments of the present application.

Referring to FIG. 6, in some scenarios (a), a set of first slots is indicated to be slot #0, the number of second slots is 1, and accordingly, slot #0 will be determined. In addition, the starting symbol (or the starting symbol index) is 7, the duration of an occasion is 2, e.g., two symbols, and the number of occasions is 3. 3 beams, e.g., beam #0 to beam #2, are configured for time domain resources and will be mapped to the three occasions, e.g., Occ #0 to Occ #2 in slot #0. Accordingly, each beam and occasion will be one to one associated in sequence.

In some scenarios (b), a set of first slots is indicated to be slot #0 and slot #1, the number of second slots is 2, and accordingly, slot #1 will be determined. In addition, the starting symbol (or the starting symbol index) is 0, the duration of an occasion is 2, e.g., two symbols, and the number of occasions is 6. 6 beams, e.g., beam #0 to beam #5, are configured for time domain resources and will be mapped to the six occasions, e.g., Occ #0 to Occ #5 in slot #1. Accordingly, each beam and occasion will be one to one associated in sequence.

### Scheme 3

Similarly to Scheme 2, in some embodiments of the present application, at least one time domain resource for the association is also determined by a set of time domain patterns, which is predefined (or preconfigured) instead of being configured. This may corresponding to SSB. Each predefined time domain pattern is associated with an SCS or a band index. The band can be a frequency domain band or an operating band.

According to some embodiments of the present application, each predefined time domain pattern indicates at least one of: a periodicity, an offset in time domain, a predefined duration in time domain, a set of slots and a set of starting symbols within each of the set of slots, or a predefined length of a time domain resource. An exemplary duration is predefined to be 5 ms. An exemplary symbol length is predefined to be 4 symbols.

Similarly, one or more configured beams (which may be indicated in a beam set or in a beam pattern) will be associated with (or mapped with) the at least one time domain resource. Each beam may be associated with a starting symbol index. In some embodiments of the present application, at least one symbol set will be determined based on each predefined time domain pattern. Mapping one or more beams to each symbol set will be started or restarted based on the offset. Exemplary mapping is similar to that illustrated in Scheme 1, and will not be specifically illustrated.

In some scenarios, based on the configured beams (first set of beams, which is deemed as a full set of beams), a second set of beams will be further indicated to the repeater, which is a subset of the first set of beams. In the case that a beam in the first set beams is also in the second set, the repeater will be on for a symbol set corresponding to the beam (transmission or reception will be performed on the symbol set, or the beam will be used in the corresponding time domain resource(s)); otherwise, the network node will be off for a symbol set corresponding to the beam (transmission or reception will not be performed on the symbol set, or the beam will not be used in the corresponding time domain resource(s)).

### Scheme 4

In some embodiments of the present application, at least one time domain resource for the association is also indicated by second information from the gNB. The second information may indicate at least one of: a slot level offset with respect to a signaling carrying the first information or a signaling carrying the second information, an SLIV or the like to indicate a starting symbol and length of symbols within a slot, a number of symbols, a repetition number (e.g., transmission or reception repetition number), and a direction (e.g., transmission or reception direction) indicator indicating whether a time domain resource is for downlink or uplink. Similarly, the at least one time domain resource can be determined based on the second information alone or in combination with other related information. Exemplary second information is TDD configuration and SSB configuration, e.g., TDD configuration and SSB configuration. This may be corresponding to PUSCH repetitions or the like.

For example, a SLIV or the like is indicated to the repeater to determine the occupied symbols within a slot, or alternatively a number of symbols will be configured. The symbols indicated by the SLIV or the number of symbols configured can be deemed as a time domain resource unit, which may be a slot or a number of symbols. For a certain determined time domain resource unit, if the corresponding time domain resource is overlapped with the time domain resource associated with the second signaling indicated in Scheme 3, then the beam of the time domain resource will be determined by Scheme 3 rather than Scheme 4. A repetition number will be configured to indicate the number of time domain resources with respect to the time domain resource unit. A direction, e.g., downlink and/or uplink will be configured for the corresponding time domain resource units.

One or more configured beams (which may be indicated in a beam set or in a beam pattern) will be associated with (or mapped with) the at least one time domain resource. In the case that there is a single beam, all determined time domain resources are associated with the beam. In the case that there are multiple beams, there will be mapping between the multiple beams and the time domain resources in various manners, e.g., similar to that illustrated in Scheme 1, or 2, or 3.

According to some embodiments of the present application, the TDD configuration is used to determine whether a time domain resource unit is actually associated with the beam or not. For example, in the case that a direction of a time domain resource is as the same as that determined based on TDD configuration, e.g., both for uplink or both for downlink, the time domain resource will be associated with a corresponding beam. Otherwise, the time domain resource will not be associated with a corresponding beam. If the directions are different, the repeater can also be considered to be off on the corresponding time domain resource. For example, if the time domain resource unit is associated with uplink, while it is determined to be for downlink based on the TDD configuration, then the indicated beam will not be used for the time domain resource. In some scenarios, the TDD configuration is determined based on at least one of: TDD configuration common (e.g. TDD-UL-DL-ConfigCommon), TDD configuration dedicated (e.g. TDD-UL-DL-ConfigDedicated), group DCI or dynamic side control information. The dynamic side control information can be used to change the direction of flexible symbols indicated by anyone of TDD configuration common and TDD configuration dedicated.

In some scenarios, there is more than one association between beams and time domain resource, wherein each association is associated with a beam set. For example, there may be multiple associations determined according to one scheme, e.g., Scheme 1 due to multiple beam sets being configured. In another example, there may be multiple associations determined according to different schemes, e.g., respectively according to two or more of Scheme 1 to Scheme 4. Thus, one association will be further determined from the multiple associations for the repeater-UE link, and accordingly the time domain resources or related other resources will be determined.

According to some embodiments of the present application, in the case that there is more than one association between beams and time domain resources, each association will be associated with a priority, and an association with a highest priority of the more than one association will be determined for a time domain resource for the repeater-UE link. The priority for each association is configured or is determined based on a corresponding time domain pattern or the used schemes. For example, Scheme 2 and Scheme 3 may be configured to have a higher priority than others. The priority can also be indicated with the information indicating the beams (beam indication or beam index indication). If there are more than one beam indications for a specific time domain resource, the repeater will select the beam with the highest priority or the smallest index or apply all the beams.

Some embodiments of the present application also consider beams for different frequency domain resources and/or different panels.

In some scenarios, there are multiple beams associated with a time domain resource, and each beam is for a frequency domain resource. Exemplary frequency domain resource is a band, a carrier, a BWP, a set of RBs or a set of RBGs. A frequency domain resource may be determined based on a starting position and a number of RBs. For example, the frequency bandwidth of the repeater for the repeater-UE link may be large, and the frequency bandwidth may be divided into several parts, each part being a band, a carrier, a BWP, a set of RBs or a set of RBGs etc., wherein a starting position and a number of RBs with respect to an SCS will be configured.

In the case that there are multiple panels in the repeater, each time domain resource with or without a frequency domain part can be associated with more than one beam. The number of beams is configured for each time domain resource with or without a frequency part. If the number of beams is more than one, then the beams configured will be divided into multiple groups, each beam group is associated with a determined time domain resource, e.g., according to anyone of Scheme 1 to Scheme 4. Beam groups can also be one to one associated with frequency domain resources.

Besides the methods, embodiments of the present application also propose an apparatus of radio resource determination.

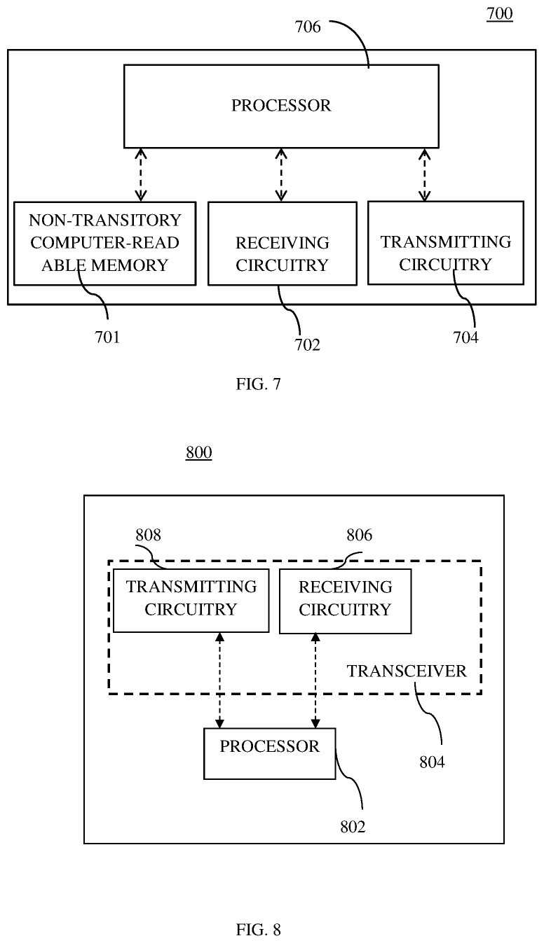

For example, FIG. 7 illustrates a block diagram of an apparatus of radio resource determination 700 according to some embodiments of the present application.

As shown in FIG. 7, the apparatus 700 may include at least one non-transitory computer-readable medium 701, at least one receiving circuitry 702, at least one transmitting circuitry 704, and at least one processor 706 coupled to the non-transitory computer-readable medium 701, the receiving circuitry 702 and the transmitting circuitry 704. The at least one processor 706 may be a CPU, a DSP, a microprocessor etc. The apparatus 700 may be a RAN node, e.g., a gNB or a repeater configured to perform a method illustrated in the above or the like.

Although in this figure, elements such as the at least one processor 706, transmitting circuitry 704, and receiving circuitry 702 are described in the singular, the plural is contemplated unless a limitation to the singular is explicitly stated. In some embodiments of the present application, the receiving circuitry 702 and the transmitting circuitry 704 can be combined into a single device, such as a transceiver. In certain embodiments of the present application, the apparatus 700 may further include an input device, a memory, and/or other components.

In some embodiments of the present application, the non-transitory computer-readable medium 701 may have stored thereon computer-executable instructions to cause a processor to implement the method with respect to the first RAN node as described above. For example, the computer-executable instructions, when executed, cause the processor 706 interacting with receiving circuitry 702 and transmitting circuitry 704, so as to perform the steps with respect to a gNB or the like as depicted above.

In some other embodiments of the present application, the non-transitory computer-readable medium 701 may have stored thereon computer-executable instructions to cause a processor to implement the method with respect to the second RAN node as described above. For example, the computer-executable instructions, when executed, cause the processor 706 interacting with receiving circuitry 702 and transmitting circuitry 704, so as to perform the steps with respect to a repeater or the like as illustrated above.

FIG. 8 is a block diagram of an apparatus of radio resource determination 800 according to some other embodiments of the present application.

Referring to FIG. 8, the apparatus 800, for example a gNB or a repeater may include at least one processor 802 and at least one transceiver 804 coupled to the at least one processor 802. The transceiver 804 may include at least one separate receiving circuitry 806 and transmitting circuitry 804, or at least one integrated receiving circuitry 806 and transmitting circuitry 804. The at least one processor 902 may be a CPU, a DSP, a microprocessor etc.

According to some embodiments of the present application, when the apparatus 800 is a repeater, the processor is configured to: receive first information indicating at least one first set of beams for a link between the repeater and a remote apparatus; and determine an association between beams and time domain resources for the link between the repeater and the remote apparatus.

According to some other embodiments of the present application, when the apparatus 800 is a gNB or the like, the processor is configured to: transmit first information indicating at least one first set of beams for a link between a repeater and a remote apparatus; and determine an association between beams and time domain resources for the link between the repeater and the remote apparatus.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A network node, comprising:
at least one memory; and
at least one processor coupled with the at least one memory and configured to cause the network node to:
receive, from another network node, first information indicating at least one first set of beams for a link between the network node and a remote apparatus; and
determine an association between beams and time domain resources for the link between the network node and the remote apparatus.

2. The network node of claim 1, wherein at least one time domain resource for the association is indicated by second information from the other network node indicating at least one of: a periodicity in time domain, an offset in time domain, a duration in time domain, a subcarrier spacing (SCS), a set of starting symbols within the duration, or a length of a time domain resource.

3. The network node of claim 2, wherein symbols are divided into symbol sets based on starting symbols and the length of a time domain resource, and each symbol set is associated with at least one beam of a corresponding set of the at least one first set of beams.

4. The network node of claim 3, wherein a number of beams associated with each symbol set is configured by the other network node.

5. The network node of claim 1, wherein at least one time domain resource for the association is indicated by second information from the other network node indicating a set of time domain patterns, each time domain pattern is associated with an index.

6. The network node of claim 5, wherein each time domain pattern is associated with at least one of the following: a frame level periodicity, an offset in time domain, at least one of a set of subframe or a set of first slot, a number of second slots, at least one starting symbol within the second slots, a number of occasions within the second slots, or a duration of an occasion.

7. The network node of claim 6, wherein a set of time domain occasions is determined based on each time domain pattern.

8. The network node of claim 7, wherein determining an
association between beams and time domain resources comprises:
starting or restarting mapping between beams in a corresponding set of the at least one first set of beams and the set of time domain occasions based on a set of starting time domain positions configured by the other network node.

9. The network node of claim 1, wherein at least one time domain resource for the association is determined by a set of predefined time domain patterns, and each predefined time domain pattern is associated with a subcarrier spacing (SCS) or a band index.

10. The network node of claim 9, wherein second set of beams of a subset of a set of the at least one first set of beams is indicated; and if a beam in the set of the at least one first set beams is also in the second set, the network node will be on for a symbol set corresponding to the beam, otherwise, the network node will be off for a symbol set corresponding to the beam.

11. The network node of claim 1, wherein at least one time domain resource for the association is indicated by second information indicating at least one of: a slot level offset with respect to a signaling carrying the first information or a signaling carrying the second information, a start and length indicator value (SLIV) to indicate a starting symbol and length of symbols within a slot, a number of symbols, a repetition number, and a direction indicator indicating whether a time domain resource is for downlink or uplink.

12. The network node of claim 11, wherein, if a direction of a time domain resource is same as that determined based on time division duplex (TDD) configuration, the time domain resource will be associated with a corresponding beam.

13. The network node of claim 1, wherein, if there is more than one association between beams and time domain resources, each association will be associated with a priority, and an association with a highest priority of the more than one association will be determined for a time domain resource for the link between the network node and the remote apparatus.

14. A network node, comprising:
at least one memory; and
at least one processor coupled with the at least one memory and configured to cause the network node to:
transmit, to another network node, first information indicating at least one first set of beams for a link between the other network node and a remote apparatus; and
determine an association between beams and time domain resources for the link between the other network node and the remote apparatus.

15. A method performed by a network node, the method comprising:
receiving, from another network node, first information indicating at least one first set of beams for a link between the network node and a remote apparatus; and
determining an association between beams and time domain resources for the link between the network node and the remote apparatus.

16. The method of claim 15, wherein at least one time domain resource for the association is indicated by second information from the other network node indicating at least one of: a periodicity in time domain, an offset in time domain, a duration in time domain, a subcarrier spacing (SCS), a set of starting symbols within the duration, or a length of a time domain resource.

17. The method of claim 16, wherein symbols are divided into symbol sets based on starting symbols and the length of a time domain resource, and each symbol set is associated with at least one beam of a corresponding set of the at least one first set of beams.

18. The method of claim 17, wherein a number of beams associated with each symbol set is configured by the other network node.

19. The method of claim 15, wherein at least one time domain resource for the association is indicated by second information from the other network node indicating a set of time domain patterns, each time domain pattern is associated with an index.

20. A method performed by a network node, the method comprising:
transmit, to another network node, first information indicating at least one first set of beams for a link between the other network node and a remote apparatus; and
determine an association between beams and time domain resources for the link between the other network node and the remote apparatus.
